(19) United States
(12) Patent Application Publication
(10) Pub. No.: US 2005/0055423 A1
(43) Pub. Date: Mar. 10, 2005

(54) Media delivering apparatus, system, method and program and recording medium having recorded program

(75) Inventor: Hiroki Tagato, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 10/936,161

(22) Filed: Sep. 8, 2004

(30) Foreign Application Priority Data
Sep. 8, 2003 (JP) 315331/2003

(51) Int. Cl. H04N 7/173; H04N 7/16; G06F 15/16

(52) U.S. Cl. 709/217; 725/135; 725/109; 725/110; 725/113

(57) ABSTRACT

By use of a media delivering apparatus, a media delivering method, and a recording medium having recorded a program in accordance with the present invention, it is possible to flexibly control delivery of video data. A media delivering apparatus in a communication network including a moving picture receiving client to receive media data via a communication network from a stream server, crime-preventive cameras connected via an LAN to the client, and storage to store image data from the cameras controls delivery of media data from the stream server to the client according to attributes of a moving picture content and the client and a moving picture service providing state to thereby flexibly control video data to be delivered.

### BACKGROUND OF THE INVENTION

1. Field of the Invention

The present invention relates to a media delivering apparatus, a system, a media delivering method and program for a media delivering, and a recording medium having recorded a program.

2. Description of the Prior Art

Recently, communication networks such as the internet have been rapidly developed. As a result, it is general practice that users of various terminals including a personal computer (PC) connect the terminals via network service providers to the internet to exchange messages by e-mail and/or to browse world wide web (WWW).

The broadband internet (and/or communication) using an asymmetric digital subscribe line (ADSL) and/or an optical fiber line (SONET/SDH) has been remarkably developed and spread today. In consequence, a moving picture service such as stream delivery of contents of a visual telephone, a movie, and a music live program which was quite difficult in the narrow band network is increasingly in great demand.

In future, in addition to the demand for the reception of moving picture contents, it will be increasingly desired that the user freely combines various contents existing in distributed places for his/her purposes according to attributes of video data items. The contents are distributed in family-use apparatuses operated in respective houses such as a hard disk (HDD) recorder of the service user, a stream server on the internet, and a network camera (a network connectable camera or an image inputting device).

Conventionally, the user can easily use the contents at distributed locations as below.

For a content viewing apparatus including a WWW browse function, storage locations of video contents are described in a hypertext markup language (HTML) file to be displayed on a browse screen. The user who desires to view a moving picture content selects the content, for example, by clicking a hyperlink displayed on the browse screen by a mouse (for example, Japanese Patent Laid-Open No. Hei11-88419).

However, in the example described in the publication, although it helps the user access the contents by displaying the distributed locations of the contents as hyperlinks in a single browse screen, only the content selected by the user is displayed. It is impossible that, for example, the contents are combined with each other to be displayed in one screen image.

### SUMMARY OF THE INVENTION

It is therefore an object of the present invention, which has been devised to solve the problems, to provide a media delivering apparatus, a media delivering method, and a recording medium having recorded a program in which video data to be delivered can be flexibly controlled according to an attribute of a moving picture content, an attribute of a moving picture receiver client, and a mobile service providing state.

In accordance with a first aspect of the present invention, there is provided a media delivering apparatus for use in a communication network including a plurality of moving picture transmitting devices such as a stream server, a network camera, and a hard disk drive (HDD) recorder having a function to, send moving picture media data via a communication network. Delivery of media data from the moving picture transmitting devices to the moving picture receiving client is controlled according to an attribute of a moving picture content, an attribute of the moving picture receiving client, and a moving picture service providing state.

In accordance with a second aspect of the present invention, the media delivering apparatus includes a content access assist unit including a content control table keeping contents of media processing to be executed according to an attribute of a moving picture content, an attribute of the moving picture receiving client, and a moving picture service providing state; a session control unit for receiving from the moving picture receiving client a content access request, an access source uniform resource locator (URL), and an access destination URL specifying a content to be viewed or audiovisually enjoyed and requesting the content access assist unit to make a search using the access source URL and the access destination URL as a key; a media processing control unit for supplying media data matching with a source address and a source port indicated by the session control unit to a media processing subfunction indicated by the session control unit, receiving a result of media processing of the subfunction, and transmitting the result to a destination address and a destination port indicated by the session control unit; a media processing unit for receiving from the media processing control unit as an input thereto media data to be processed and a specification of a type of a subfunction module to process the media data, executing predetermined data processing by a function module thus specified, and returning media data resultant from the processing to the media processing control unit; a media data receiving unit for receiving media data sent from a moving picture content source and delivering the media data to the media processing unit; and a media data transmitting unit for receiving the media data from the media processing control unit and transmitting the media data to the moving picture receiving client.

In accordance with a third aspect of the present invention, the content access assist unit makes, when a content control table search request is received from the session control unit with the access source URL and the access destination URL as transfer data, a search through the content control table using the transfer data as a key and returns, when an entry matching with the key is detected, as a search result a converted URL, a media processing condition, and media processing contents to the session control unit.

In accordance with a fourth aspect of the present invention, the session control unit conducts, for the converted URL returned from the content access assist unit, a session setup request to a moving picture content source specified by the URL.

In accordance with a fifth aspect of the present invention, the session control unit interprets the session processing condition and the session processing contents returned from the content access assist unit, makes a search through contents of the session control table thereof using as a key the access source URL and the access destination URL passed from the moving picture receiving client; and the session control unit instructs the media processing unit, when an entry matching with the key is detected, to make a subfunction module in a media processing function for executing specified media processing execute media data belonging to an associated session.

In accordance with a sixth aspect of the present invention, there is provided a media delivering method of delivering at least one of a plurality of media data items sent from a plurality of moving picture transmitting devices to a moving picture receiving client receiving media data via a communication network from the moving picture transmitting devices. Delivery of media data from the moving picture transmitting devices to the moving picture receiving client is controlled according to an attribute of a moving picture content, an attribute of the moving picture receiving client, and a moving picture service providing state.

In accordance with a seventh aspect of the present invention, the media delivering method includes a content access assist step for making a content control table keep contents of media processing to be executed according to an attribute of a moving picture content, an attribute of the moving picture receiving client, and a moving picture service providing state; a session control step of receiving from the moving picture receiving client a content access request, an access source URL, and an access destination URL specifying a content to be viewed and requesting a search through the content control table using the access source URL and the access destination URL as a key; a media processing control step of supplying media data matching with a source address and a source port indicated during the session control step to a media processing subfunction indicated during the session control step, receiving a result of media processing of the subfunction, and transmitting the result to a destination address and a destination port indicated during the session control step; a media processing step for receiving during the media processing control step as an input thereto media data to be processed and a specification of a type of a subfunction module to process the media data, executing predetermined data processing by a function module thus specified, and returning media data resultant from the processing to the media processing control step; a media data receiving step of receiving media data sent from a moving picture content source and delivering the media data to the media processing step; and a media data transmitting step of receiving the media data from the media processing control step and transmitting the media data to the moving picture receiving client.

In accordance with an eighth aspect of the present invention, the content access assist step makes, when a content control table search request is received from the session control step with the access source URL and the access destination URL as transfer data, a search through the content control table using the transfer data as a key and returns, when an entry matching with the key is detected, as a search result a converted URL, a media processing condition, and media processing contents to the session control step.

In accordance with a ninth aspect of the present invention, the session control step conducts, for the converted URL returned from the content access assist step, a session setup request to a moving picture content source specified by the URL.

In accordance with a tenth aspect of the present invention, the session control step interprets the session processing condition and the session processing contents returned from the content access assist step, makes a search through contents of the session control table thereof using as a key the access source URL and the access destination URL passed from the moving picture receiving client; and the session control step instructs the media processing step, when an entry matching with the key is detected, to make a subfunction module in a media processing function for executing specified media processing execute media data belonging to an associated session.

In accordance with an 11th aspect of the present invention, there is provided a recording media having stored a program product for delivering at least one of a plurality of media data items sent from a plurality of moving picture transmitting devices to a moving picture receiving client receiving media data via a communication network from the moving picture transmitting devices. Delivery of media data from the moving picture transmitting devices to the moving picture receiving client is controlled according to an attribute of a moving picture content, an attribute of the moving picture receiving client, and a moving picture service providing state.

In the media delivering apparatus, the media delivering method, and the recording medium having recorded a program in accordance with the present invention, video data to be delivered can be flexibly controlled according to an attribute of a moving picture content, an attribute of a moving picture receiving client, and a moving picture service providing state.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a configuration of an embodiment of a communication network including a media delivering apparatus using a media delivering method in accordance with the present invention;

FIG. 2 is a block diagram showing a configuration of a media delivering apparatus in accordance with the present invention;

FIG. 3 is a schematic diagram to explain an internal configuration of a content control table shown in FIG. 2;

FIG. 4 is a diagram to explain an internal configuration of a session control table;

FIG. 5 is a operation sequence chart of a media delivering apparatus using a media delivering method in accordance with the present invention; and

FIG. 6 is an operation sequence chart of a media delivering apparatus using a media delivering method in accordance with the present invention.

### DESCRIPTION OF THE EMBODIMENTS

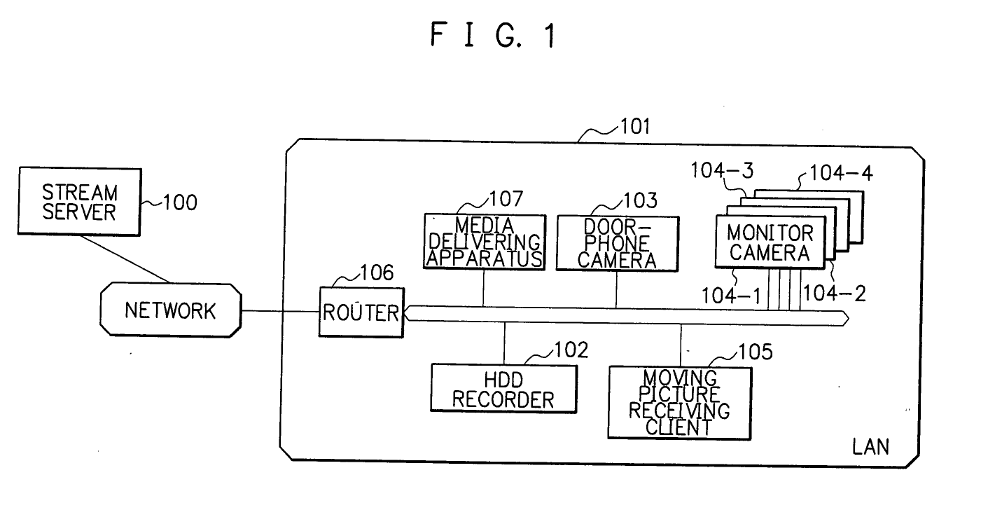

FIG. 1 shows in a block diagram a configuration of an embodiment of a communication network system in which a media delivering apparatus 107 operates in a media delivering method in accordance with the present invention.

The network as shown in FIG. 1 includes, as moving picture content supply source blocks, a stream server 100 on the internet, an HDD recorder 102 as a storage in a LAN (local area network(s)) or WAN (wide area network(s)) 101, a door-phone camera 103 or an imaging input device near door as a camera for crime prevention, and a plurality of monitor cameras 1 to 4 (104-1 to 104-4; the number of monitor cameras is not limited in FIG. 1). The system also includes a media delivering apparatus 107.

The local area network 101 includes a moving picture receiving or viewing client 105. The client can access via a router 106 a moving picture content in the stream server 100, a video content stored in the HDD recorder 102 in the LAN 101, or a video content produced from one of the cameras 104-1 to 104-4 to resultantly display the moving picture (and audio data in accordance with the picture) content.

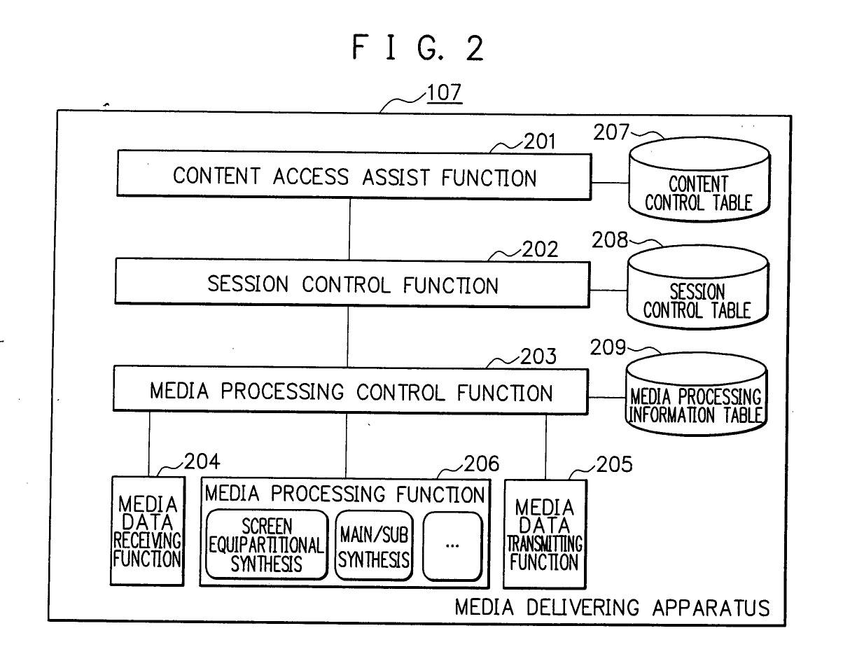

FIG. 2 is a block diagram showing an outline of a configuration of a media delivering apparatus in accordance with the present invention in.

As can be seen in FIG. 2, the media delivering apparatus 107 includes a content access assist function module 201, a session control function module 202, a media processing control function module 203, a media data receiving function module 204, a media data transmitting function module 205, and a media processing function module 206.

The content access assist function module 201 controls a content control table 207 which keeps the contents of media processing to be executed by the media delivering apparatus 107 of FIG. 1 in association with a content type of a moving picture, an access source client type, and a moving picture providing state.

The content access assist function module 201 receives a content control table search request with data items of an access source URL and an access destination URL from the session control function module 202. The function module 201 then makes a search through the content control table 207 using the data items as a search key. When a matching entry is detected, the function 201 returns to the session control function module 202 a search result including a converted URL, a media processing condition, and media processing contents.

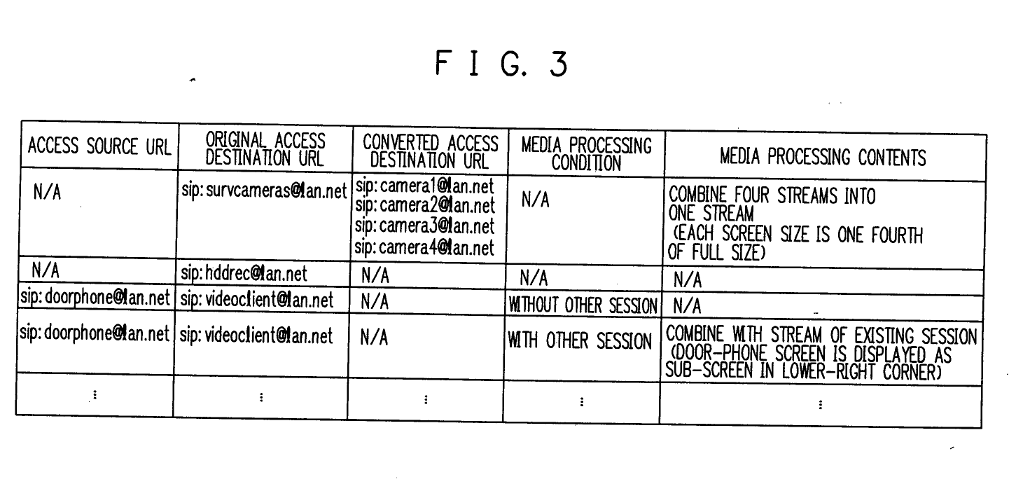

FIG. 3 shows a diagram to explain an internal configuration of the content control table shown in FIG. 2.

The session control function module 202 receives from the moving picture receiving client 105 a content access request, an access source URL (URL of the client 105), and an access destination URL indicating a content to be received. The function module 202 then issues a search request to the content access assist function module 201 to make a search using the access source URL and the access destination URL as a key.

For a converted URL returned from the content access assist function module 201, the function module 202 issues a session setup request to a moving picture content source indicated by the URL. When a plurality of converted URLs are returned, the session is set up for each thereof.

Any session established as above is added to the session control table 208 of the session control function module 202 as an entry to be controlled by the function module 202.

Additionally, the session control function module 202 interprets the session processing condition and the session processing contents returned from the content access assist function module 201. The function module 202 makes a search through the table 208 using as a key the access source URL and the access destination URL transferred from the moving picture receiving client 105 of FIG. 1. When a matching entry is detected, the function module 202 indicates the media processing function module 206 to make a sub-function module of the media processing function for specified executing media processing execute media data belonging to an associated session.

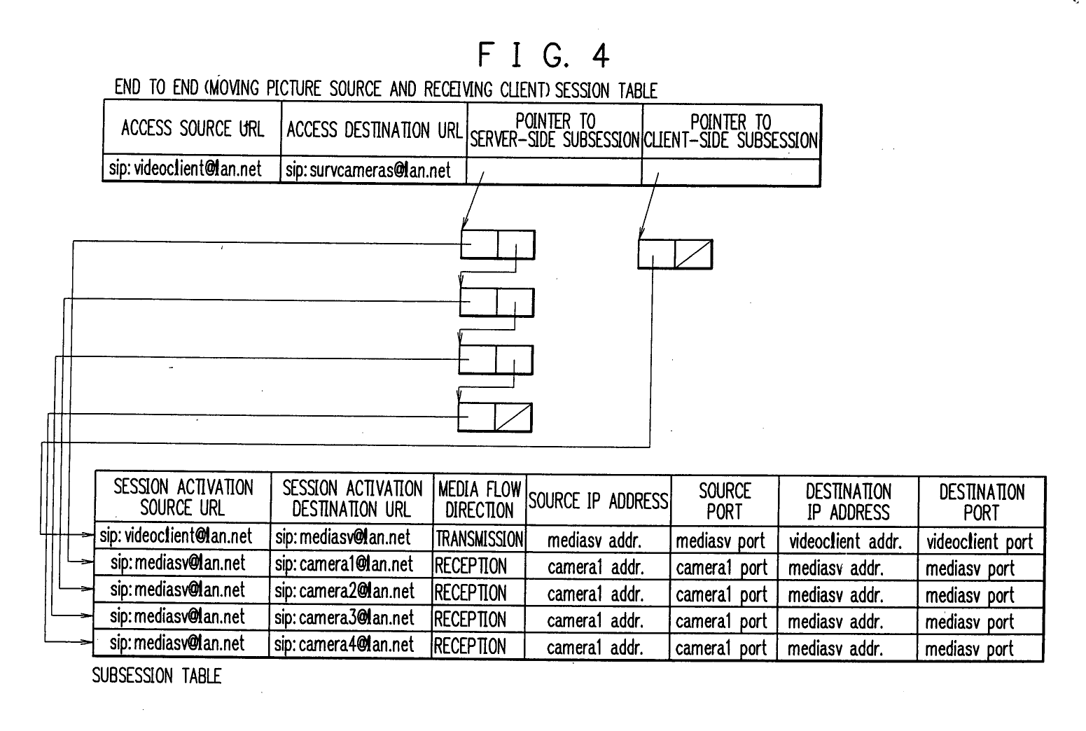

FIG. 4 shows an internal configuration of the session control table 208.

The media processing control function module 203 of FIG. 2 supplies the indicated media processing subfunction with media data matching with a source address and a source port specified by the session control function module 202 of FIG. 2 to receive a result of the processing of the media processing subfunction. The function module 203 then transmits the result to an indicated destination address and an indicated destination port.

When the media processing control function module 203 inputs media data to be processed and a specification of a type of a subfunction module to process the media data, the media processing function module 206 executes predetermined data processing by the specified module and then returns media data resultant from the processing to the control function module 203.

The media data receiving function module 204 receives media data sent from a moving picture content source and feeds the data to the control function module 203. The media data transmitting function module 205 transmits the media data delivered from the media processing control function module 203 to the moving picture receiving client 105 of FIG. 1.

Operation

Referring now to the drawings, description will be given of an example of a processing procedure when a moving picture content access is received from a moving picture receiving client in the media delivery in accordance with the present invention.

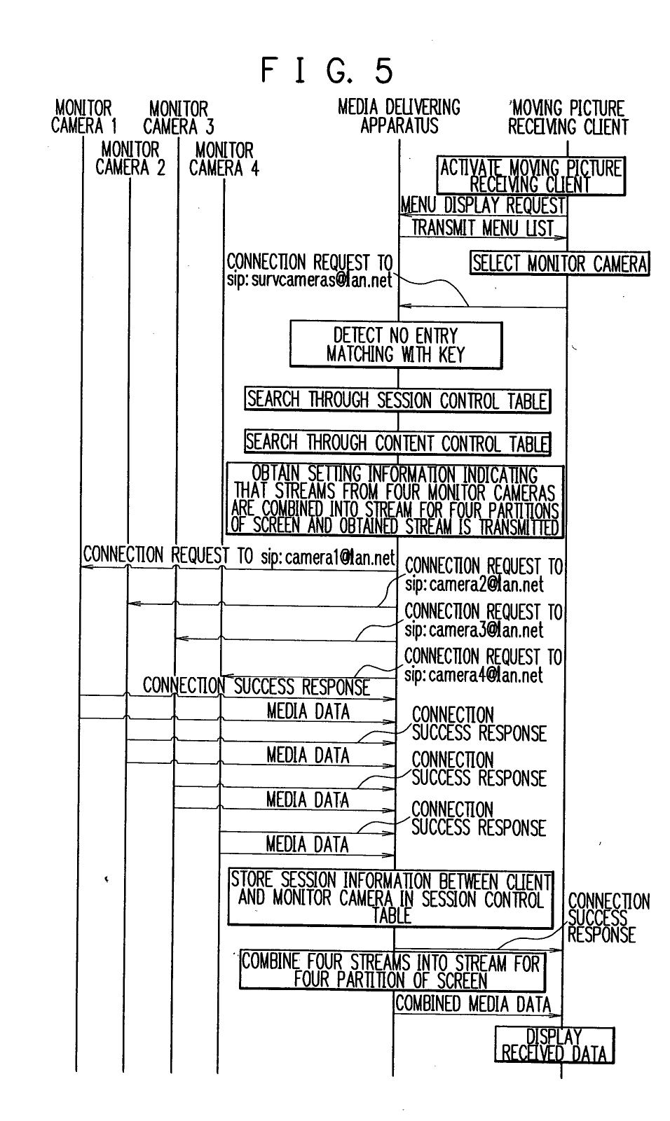

FIG. 5 shows an operation sequence chart of a media delivering apparatus operating in a media delivering method in accordance with the present invention.

In the sequence chart, the moving picture receiving client (client personal computer) 105 is activated and then images from at least one of the plurality of monitor cameras 104-1 to 104-4 connected to the LAN 101 are combined into one stream including, for example, four equal partitions of the screen, and then the combined image is displayed (on the client 105, for example).

When the client 105 is activated, the client 105 issues a request to the media delivering apparatus 107 to display a menu. In response to the request, the apparatus 107 sends a menu including the screen image information on the screen to the client 105.

When the client 105 selects (at least one of) the cameras 1 to 4 (104-1 to 104-4), the client 105 transmits to the apparatus 107 a request to set up connection to a URL (sip:survcameras@lan.net) indicating the cameras 104-1 to 104-4.

The apparatus 107 makes a search through the session control table 208 of FIG. 2 using a URL (sip:videoclient@lan.net) indicating the client 105 and a URL (sip:survcameras@lan.net) indicating the cameras 104-1 to 104-4 as a search key. In this case, there exists no entry matching with the key.

When a matching entry is detected, that is when the client 105 again selects viewing of the cameras 104-1 to 104-4 while the client 105 is receiving images therefrom, the apparatus 107 returns a connection success response to the client 105. This does not exert any influence upon the image being received by the client 105.

Next, the apparatus 107 makes a search through the content control table 207 using the same search key. It is resultantly detected that the key is set for the operation below. That is, sip:survcameras@lan.net is converted into URLs of sip:camera1@lan.net, sip:camera2@lan.net, sip:camera3@lan.net, and sip:camera4@lan.net. Moreover, media streams sent from the four cameras 104-1 to 104-4 are combined into one stream of four partitions of the screen and the stream is sent to the client 105.

The media delivering apparatus 107 then transmits a connection request to each URL of four cameras 104-1 to 104-4. When a connection success response is returned from all URLs, the apparatus 107 creates information in the session control table 208 to indicate that a session is set up between the client 105 (sip:videoclient@lan.net) and the monitor cameras 104-1 to 104-4 (sip:survcameras@lan.net). For the server-side session, session information between the apparatus 107 and four cameras 104-1 to 104-4 is stored. For the client-side session, session information between the client 105 and the apparatus 107 is stored.

After having created the entry in the session control table 208, the media delivering apparatus 107 sends a connection success message to the client 105. The apparatus 107 then transmits to the client 105 the media data for which the media processing has been executed (to combine four streams into one stream and to divide one screen into four partitions). When the media data is received, the client 105 displays the data.

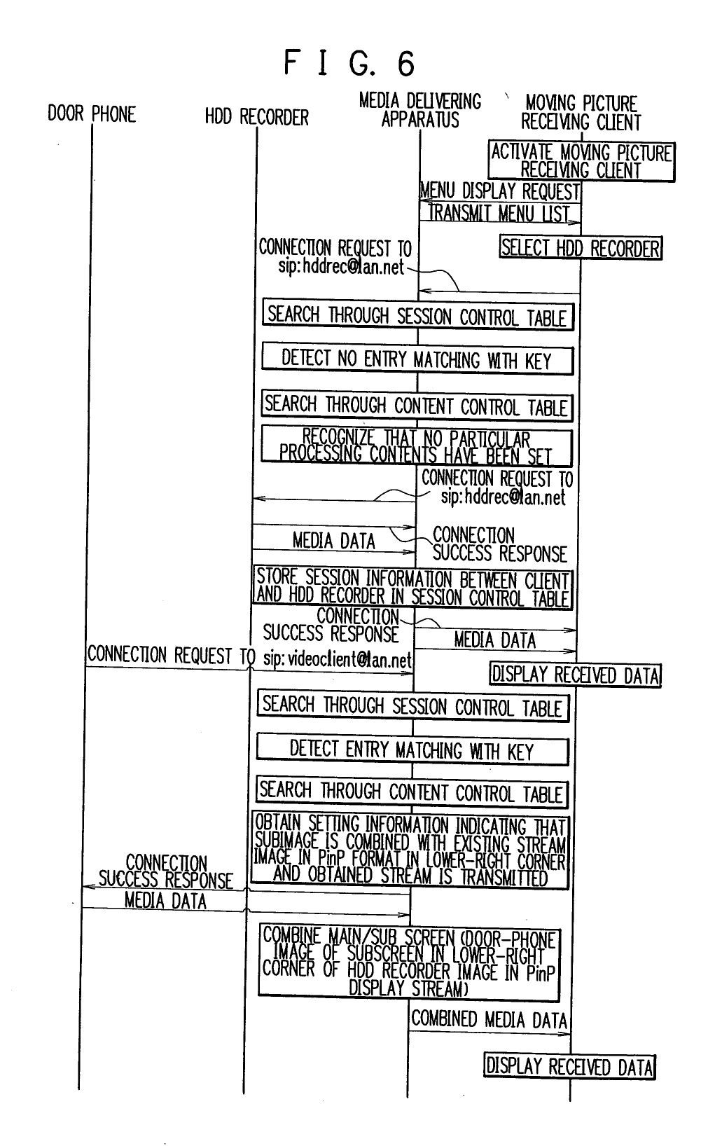

FIG. 6 shows an operation sequence chart of a media delivering apparatus to conduct operation in a media delivering method in accordance with the present invention.

The sequence chart covers operation as below. The moving picture receiving client 105 is activated. While viewing a video content from an HDD recorder connected to the LAN, the user has a visitor. A video content from the door-phone camera 103 is displayed in a picture-in-picture:small picture superimposed on large picture (PinP) format of a subscreen display mode on the screen of the moving picture content from the HDD recorder.

When the client 105 is activated, the client 105 requests the media delivering apparatus 107 to display a menu. In response thereto, the apparatus 107 delivers a menu screen to the client 105.

When the client 105 selects the HDD recorder 102, the client 105 transmits to the apparatus 107 a request for connection to a URL (sip:hddrec@lan.net) indicating the HDD recorder 102.

The apparatus 107 makes a retrieval through the session control table 208 using a URL (sip:videoclient@lan.net) designating the client 105 and a URL (sip:hddrec@lan.net) indicating the HDD recorder 102 as a retrieval key. In this situation, there exists no entry matching with the key.

When a matching entry is detected and if the client 105 again selects the HDD recorder while receiving an image from the HDD recorder 102, the apparatus 107 returns a connection success response to the client 105.

The image being received by the client 105 is not influenced by the operation described above.

Subsequently, the apparatus 107 makes a search through the content control table 207 using the same search key. As a result, a situation is recognized, that is, any particular operation has not been set for the key.

Thereafter, the media delivering apparatus 107 sends a connection request to the HDD recorder 102. When a connection success response is returned from the recorder 102, the apparatus 107 generates information in the session control table 208 to indicate that a session is established between the client 105 (sip:videoclient@lan.net) and the HDD recorder 102 (sip:hddrec@lan.net). In the operation, session information between the apparatus 107 and the HDD recorder 102 is stored as the server-side session. Session information between the client 105 and the apparatus 107 is stored as the client-side session.

After having produced the entry in the session control table 208, the apparatus 107 transmits a connection success message to the client 105. The apparatus 107 then delivers to the client 105 the media data from the HDD recorder 102. The client 105 displays the data received from the apparatus 107.

Next, due to an event in which, for example, the client 105 has a visitor while the client 105 is receiving an video image from the HDD recorder 102, a connection request is sent to the media delivering apparatus 107 for connection from the door-phone camera 103 to the client 105 (sip:videoclient@lan.net).

Having received the request, the apparatus 107 makes a search through the session control table 208 using a URL (sip:doorphone@lan.net) indicating the door-phone camera 103 and a URL (sip:videoclient@lan.net) indicating the client 105 as a search key. In this case, the system produces an entry in the table 208 as a result of the search, the entry including sip:videoclient@lan.net as an access source URL and sip:hddrec@lan.net as an access destination URL.

The apparatus 107 makes a search through the content control table 207 using the same search key. It is recognized as a result that the key is set for the operation as follows. That is, since other session is existing in this state, a media stream sent from the door-phone camera 103 is combined with an existing media stream from the HDD recorder 102 into one media stream. The stream is sent to the client to display an image of the camera 103 as part of the main screen, namely, to display an image of a subscreen in the picture-in-picture (PinP) format on the lower-right corner of the screen.

Thereafter, the media delivering apparatus 107 transmits a connection success response to the camera 103. The apparatus 107 then receives media data from the camera 103 and executes media processing beforehand set to display the image from the camera 103 in a subscreen in the picture-in-picture format in the lower-right corner of the main screen. The apparatus 107 delivers media data resultant from the processing to the client 105. Since the image from the camera 103 is displayed in the picture-in-picture format over the image from the HDD recorder 102, the client 105 can recognize that he or she has a visitor.

The present invention is not restricted by the media delivering apparatus and the media delivering method but is applicable to a recording medium such as a flexible disk, compact disk read-only memory (CD-ROM or DVD-ROM), or an HDD having recorded a program of the media delivering method. The recording medium has recorded a program to deliver, to a moving picture receiving client to receive media data via a network from a stream server, at least one of media data and image data from a crime-preventive camera connected via a local area network to the client. The program controls delivery of media data from the stream server to the client according to an attribute of a moving picture content, an attribute of the moving picture receiving client, and a moving picture service providing state. The client 105 and the apparatus 107 may be personal computers and each of the computers include an CPU (central processing unit) respectively, and may include a cache memory, a hard disk, a primary storage, a ROM (read only memory), a RAM (random access memory) and a modem, respectively. And the program according to the present invention may store in the client 105 and the apparatus 107, independently or dependently.

As above, by use of the media delivering apparatus, the system, the media delivering method and the program, and the recording medium having recorded a program in accordance with the present invention, it is possible to achieve seamless or smooth access to video contents existing in distributed locations on a network.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A media delivering apparatus for use in a communication network including a plurality of moving picture transmitting devices including a stream server, a network camera, and a hard disk drive (HDD) recorder having a function to send moving picture media data via a communication network, wherein
delivery of media data from the moving picture transmitting devices to the moving picture receiving client is controlled according to an attribute of a moving picture content, an attribute of the moving picture receiving client, and a moving picture service providing state.

2. A media delivering apparatus in accordance with claim 1, comprising:
a content access assisting part including a content control table keeping contents of media processing to be executed according to an attribute of a moving picture content, an attribute of the moving picture receiving client, and a moving picture service providing state;
a session controller for receiving from the moving picture receiving client a content access request, an access source universal resource locator (URL), and an access destination URL specifying a content to be received and requesting the content access assisting part to make a search using the access source URL and the access destination URL as a key;
a media processing controller for supplying media data matching with a source address and a source port indicated by the session controller to a media processing subfunction indicated by the session controller, receiving a result of media processing of the subfunction, and transmitting the result to a destination address and a destination port indicated by the session controller;
a media processing part for receiving from the media processing controller as an input thereto media data to be processed and a specification of a type of a subfunction module to process the media data, executing predetermined data processing by a function module thus specified, and returning media data resultant from the processing to the media processing controller;
a media data receiver for receiving media data sent from a moving picture content source and delivering the media data to the media processing part; and
a media data transmitter for receiving the media data from the media processing controller and transmitting the media data to the moving picture receiving client.

3. A media delivering apparatus in accordance with claim 2, wherein the content access assisting part makes, when a content control table search request is received from the session controller with the access source URL and the access destination URL as transfer data, a search through the content control table using the transfer data as a key and returns, when an entry matching with the key is detected, as a search result a converted URL, a media processing condition, and media processing contents to the session controller.

4. A media delivering apparatus in accordance with claim 2, wherein the session controller conducts, for the converted URL returned from the content access assisting part, a session setup request to a moving picture content source specified by the URL.

5. A media delivering apparatus in accordance with claim 2, wherein
the session controller interprets the session processing condition and the session processing contents returned from the content access assisting part, makes a search through contents of the session control table thereof using as a key the access source URL and the access destination URL passed from the moving picture receiving client; and
the session controller instructs the media processing part when an entry matching with the key is detected, to make a subfunction module in a media processing function for executing specified media processing execute media data belonging to an associated session.

6. A media delivering apparatus in accordance with claim 4, wherein
the session controller interprets the session processing condition and the session processing contents returned from the content access assisting part, makes a search through contents of the session control table thereof using as a key the access source URL and the access destination URL passed from the moving picture receiving client; and
the session controller instructs the media processing part when an entry matching with the key is detected, to make a subfunction module in a media processing function for executing specified media processing execute media data belonging to an associated session.

7. A media delivering system comprising;
a media delivering apparatus in accordance with claim 1,
a plurality of moving picture transmitting devices including a stream server, a network camera, and a hard disk drive (HDD) recorder having a function to send moving picture media data via a communication network,
a stream server stored moving picture contents via a communication network and
a plurality of a moving picture receiving client,
wherein delivery of media data from the moving picture transmitting devices to the moving picture receiving client is controlled according to an attribute of a moving picture content, an attribute of the moving picture receiving client, and a moving picture service providing state.

8. A media delivering system comprising;
a media delivering apparatus in accordance with claim 2,
a plurality of moving picture transmitting devices including a stream server, a network camera, and a hard disk drive (HDD) recorder having a function to send moving picture media data via a communication network,
a stream server stored moving picture contents via a communication network and
a plurality of a moving picture receiving client,
wherein delivery of media data from the moving picture transmitting devices to the moving picture receiving client is controlled according to an attribute of a moving picture content, an attribute of the moving picture receiving client, and a moving picture service providing state.

9. A media delivering system comprising;
a media delivering apparatus in accordance with claim 3,
a plurality of moving picture transmitting devices including a stream server, a network camera, and a hard disk drive (HDD) recorder having a function to send moving picture media data via a communication network,
a stream server stored moving picture contents via a communication network and
a plurality of a moving picture receiving client,
wherein delivery of media data from the moving picture transmitting devices to the moving picture receiving client is controlled according to an attribute of a moving picture content, an attribute of the moving picture receiving client, and a moving picture service providing state.

10. A media delivering system comprising;
a media delivering apparatus in accordance with claim 4,
a plurality of moving picture transmitting devices including a stream server, a network camera, and a hard disk drive (HDD) recorder having a function to send moving picture media data via a communication network,
a stream server stored moving picture contents via a communication network and
a plurality of a moving picture receiving client,
wherein delivery of media data from the moving picture transmitting devices to the moving picture receiving client is controlled according to an attribute of a moving picture content, an attribute of the moving picture receiving client, and a moving picture service providing state.

11. A media delivering system comprising;
a media delivering apparatus in accordance with claim 5,
a plurality of moving picture transmitting devices including a stream server, a network camera, and a hard disk drive (HDD) recorder having a function to send moving picture media data via a communication network,
a stream server stored moving picture contents via a communication network and
a plurality of a moving picture receiving client,
wherein delivery of media data from the moving picture transmitting devices to the moving picture receiving client is controlled according to an attribute of a moving picture content, an attribute of the moving picture receiving client, and a moving picture service providing state.

12. A media delivering system comprising;
a media delivering apparatus in accordance with claim 6,
a plurality of moving picture transmitting devices including a stream server, a network camera, and a hard disk drive (HDD) recorder having a function to send moving picture media data via a communication network,
a stream server stored moving picture contents via a communication network and
a plurality of a moving picture receiving client,
wherein delivery of media data from the moving picture transmitting devices to the moving picture receiving client is controlled according to an attribute of a moving picture content, an attribute of the moving picture receiving client, and a moving picture service providing state.

13. A program for executing a delivering system in accordance with 8,
the program for delivering at least one of a plurality of media data items sent from a plurality of moving picture transmitting devices to a moving picture receiving client receiving media data via a communication network from the moving picture transmitting devices, to execute a delivering system wherein
a content access assist step for making a content control table keep contents of media processing to be executed according to an attribute of a moving picture content, an attribute of the moving picture receiving client, and a moving picture service providing state executing the content access assist, the content access assist step is executed by the content access assisting part;
a cession control step of receiving from the moving picture receiving client a content access request, an access source URL, and an access destination URL specifying a content to be received and requesting a search through the content control table using the access source URL and the access destination URL as a key, cession control step is executed by the session controller;
a media processing control step of supplying media data matching with a source address and a source port indicated during the session control step to a media processing subfunction indicated during the session control step, receiving a result of media processing of the subfunction, and transmitting the result to a destination address and a destination port indicated during the session control step, the media processing control step is executed by the media processing controller;
a media processing step for receiving during the media processing control step as an input thereto media data to be processed and a specification of a type of a subfunction module to process the media data, executing predetermined data processing by a function module thus specified, and returning media data resultant from the processing to the media processing control step, the media processing step is executed by the media processing part;
a media data receiving step of receiving media data sent from a moving picture content source and delivering the media data to the media processing step, the media data receiving step is executed by the media data receiver; and
a media data transmitting step of receiving the media data from the media processing control step and transmitting the media data to the moving picture receiving client, the media data transmitting step is executed by the media data transmitter.

14. A media delivering method of delivering at least one of a plurality of media data items sent from a plurality of moving picture transmitting devices to a moving picture receiving client receiving media data via a communication network from the moving picture transmitting devices, wherein
delivery of media data from the moving picture transmitting devices to the moving picture receiving client is controlled according to an attribute of a moving picture content, an attribute of the moving picture receiving client, and a moving picture service providing state.

15. A media delivering method in accordance with claim 14, comprising:
a content access assist step for making a content control table keep contents of media processing to be executed according to an attribute of a moving picture content, an attribute of the moving picture receiving client, and a moving picture service providing state;
a session control step of receiving from the moving picture receiving client a content access request, an access source URL, and an access destination URL specifying a content to be received and requesting a search through the content control table using the access source URL and the access destination URL as a key;
a media processing control step of supplying media data matching with a source address and a source port indicated during the session control step to a media processing subfunction indicated during the session control step, receiving a result of media processing of the subfunction, and transmitting the result to a destination address and a destination port indicated during the session control step;
a media processing step for receiving during the media processing control step as an input thereto media data to be processed and a specification of a type of a subfunction module to process the media data, executing predetermined data processing by a function module thus specified, and returning media data resultant from the processing to the media processing control step;
a media data receiving step of receiving media data sent from a moving picture content source and delivering the media data to the media processing step; and
a media data transmitting step of receiving the media data from the media processing control step and transmitting the media data to the moving picture receiving client.

16. A media delivering method in accordance with claim 15, wherein the content access assist step makes, when a content control table search request is received from the session control step with the access source URL and the access destination URL as transfer data, a search through the content control table using the transfer data as a key and returns, when an entry matching with the key is detected, as a search result a converted URL, a media processing condition, and media processing contents to the session control step.

17. A media delivering method in accordance with claim 15, wherein the session control step conducts, for the converted URL returned from the content access assist step, a session setup request to a moving picture content source specified by the URL.

18. A media delivering method in accordance with claim 15, wherein
the session control step interprets the session processing condition and the session processing contents returned from the content access assist step, makes a search through contents of the session control table thereof using as a key the access source URL and the access destination URL passed from the moving picture receiving client; and
the session control step instructs the media processing step, when an entry matching with the key is detected, to make a subfunction module in a media processing function for executing specified media processing execute media data belonging to an associated session.

19. A media delivering method in accordance with claim 17, wherein
the session control step interprets the session processing condition and the session processing contents returned from the content access assist step, makes a search through contents of the session control table thereof using as a key the access source URL and the access destination URL passed from the moving picture receiving client; and
the session control step instructs the media processing step, when an entry matching with the key is detected, to make a subfunction module in a media processing function for executing specified media processing execute media data belonging to an associated session.

20. A recording media having stored a program product for delivering at least one of a plurality of media data items sent from a plurality of moving picture transmitting devices to a moving picture receiving client receiving media data via a communication network from the moving picture transmitting devices, wherein
delivery of media data from the moving picture transmitting devices to the moving picture receiving client is controlled according to an attribute of a moving picture content, an attribute of the moving picture receiving client, and a moving picture service providing state.
